(19) United States
(12) Patent Application Publication
(10) Pub. No.: US 2010/0189579 A1
(43) Pub. Date: Jul. 29, 2010

(54) PNEUMATIC COMPONENT

(76) Inventors: Jens-Thorsten Gronau, Hameln (DE); Mike Heurich, Apelern (DE); Tino Wiggers, Seelze (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/452,245

(22) PCT Filed: Jun. 26, 2008
(86) PCT No.: PCT/EP2008/005217

§ 371 Date: Feb. 17, 2010

(30) Foreign Application Priority Data
Jul. 26, 2007 (DE) 10 2007 034 978.7

(51) Int. Cl. F04B 39/00; F16J 1/00; F16J 9/00; B23P 23/00; F16J 9/28

(52) U.S. Cl. 417/437; 92/172; 92/248; 29/888.049; 277/434

(57) ABSTRACT

The invention relates to a pneumatic component with a cylinder (12); a piston (14) running in the cylinder and a grooved ring (16), which seals the piston (14) from the cylinder (12) and has a static side (Sₛₜₐₜ) and a dynamic side (S_{dyn}). According Co the invention, the grooved ring (16) has at least two concentric microlips (38) on the static side (Sₛₜₐₜ).

The present invention relates to a pneumatic component comprising a cylinder, a piston running in the cylinder, and a grooved ring that seals the piston with respect to the cylinder and that has a static side and a dynamic side.

Pneumatic components of the general type under consideration are used, for example, in the form of compressors, in particular as piston air compressors, in trucks or passenger cars. The compressor piston has a circumferential groove, in which a grooved ring engages. The grooved ring seals the piston with respect to the cylinder. In order to reduce the production cost, the compressor piston is in part produced by an injection molding process. In the course of this process, mold parting flash running in the longitudinal direction of the piston is left behind. This mold parting flash must be removed by a machining process in order to be able to draw separately produced rubber grooved rings onto the piston. Without removal of the mold parting flash, the grooved ring does not sit sufficiently tightly on the piston.

A disadvantage of such conventional pneumatic components is therefore the complicated manufacture thereof. In an alternative production process, in order to make the removal of the mold parting flash unnecessary, the rubber ring is first vulcanized in a seated position on the piston. A disadvantage of this is that, for piston diameters of more than 70 mm, this process has such a low degree of reliability that it cannot be used in the course of mass production.

The object of the present invention is to overcome the disadvantages associated with conventional pneumatic components.

The present invention solves the problem by a pneumatic component in which the grooved ring has at least two concentric microlips on the static side.

An advantage of this construction is that the piston can be made of plastic by injection molding, for example, without the mold parting flash having to be removed. This is because the microlips, despite mold parting flash, provide for an airtight connection between the piston and the grooved ring. The grooved rings can be advantageously produced separately even at a diameter of more than 70 mm and can subsequently be connected to an injection-molded piston.

In addition, advantageously, a high degree of tightness can be achieved despite the presence of mold parting flash, and therefore sealing grease can largely be dispensed with.

Within the scope of the present description, the dynamic side refers to that side of the grooved ring that rubs on another component during operation of the pneumatic component. The static side, on the other hand, is that side that, during operation of the pneumatic component, rests relative to the component to which the grooved ring is attached.

In a preferred embodiment, the grooved ring is fastened to the piston such that its static side faces the piston. The advantage thereof is that the piston can be produced from plastic in an injection molding process without having to remove the mold parting flash in a complicated manner, which is unavoidably produced in the process. Producing the piston from plastic results in a piston that is especially easy and simple to produce.

Desirably, the grooved ring is fastened to the piston such that the mold parting flash intersects the microlips. If the mold parting flash runs, for example, in the longitudinal direction of the piston, it is advantageous if the microlips intersect the mold parting flash substantially perpendicularly.

For a good sealing effect with, at the same time, reliable retention of the grooved ring on the piston, it is preferred that the microlips project by less than 0.5 mm beyond a base area.

It is particularly advantageous if the piston has a diameter of more than 70 mm. In this case, the pneumatic component can be constructed with an especially large swept volume without the mold parting flash having to be removed. At such diameters, vulcanizing the grooved ring in place is no longer possible.

It is desirable that the grooved ring be made of rubber since such grooved rings have an especially long service life.

An especially good sealing effect is achieved if the grooved ring has multiple concentric microlips, for example 3, 4, 5 or more microlips.

A pneumatic component according to the present invention can be used as an air compressor, in particular for a pneumatic system of a utility vehicle. Alternatively, a pneumatic component according to the invention can be used as a pneumatic actuator, in particular as a pneumatic gearshift control.

The present invention is discussed in greater detail hereinafter with reference to the attached drawings, in which:

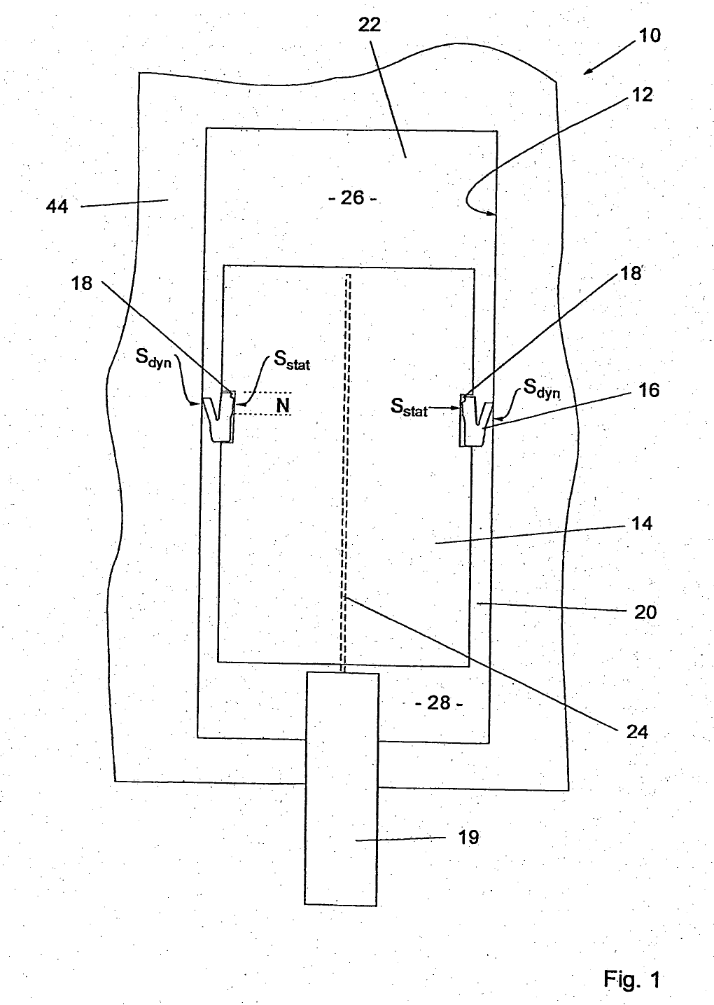

FIG. 1 is a schematic cross section through a pneumatic component according to an embodiment of the present invention;

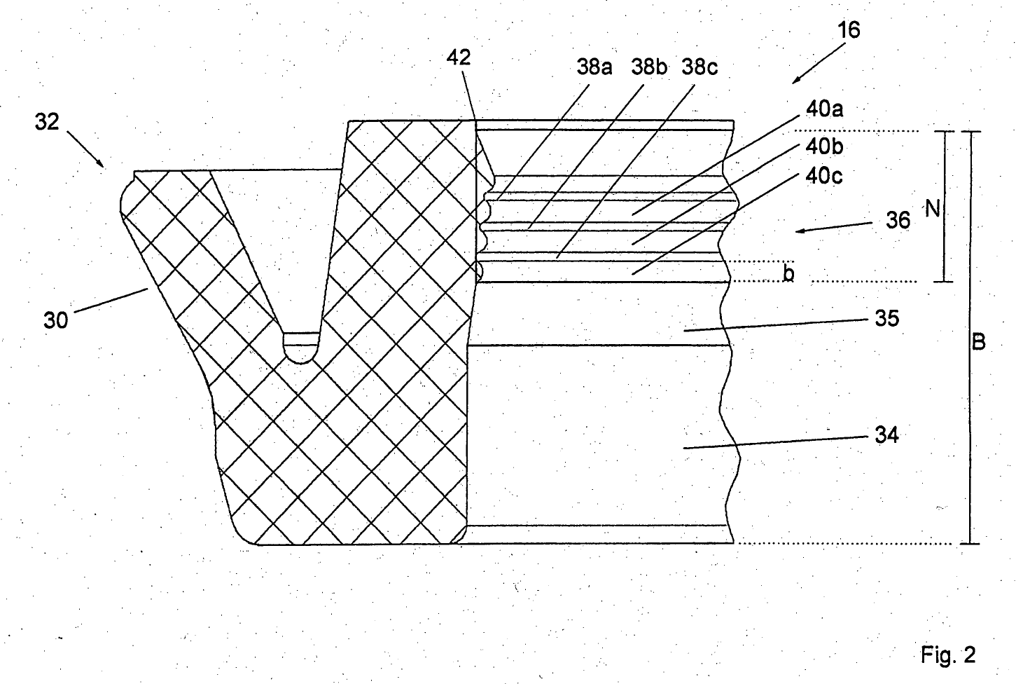

FIG. 2 shows a detail of a grooved ring of a pneumatic component according to an embodiment of the present invention; and

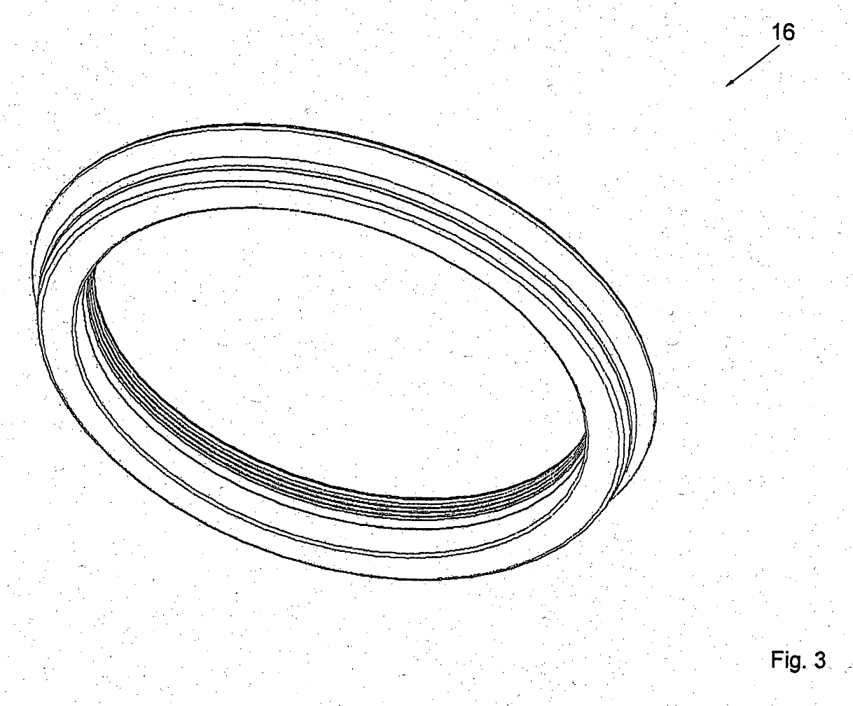

FIG. 3 shows a three-dimensional view of a grooved ring for a pneumatic component according to an embodiment of the present invention.

FIG. 1 shows a pneumatic component in the form of a compressor 10 that includes a cylinder 12, a piston 14 running in the cylinder 12, and a grooved ring 16. The grooved ring 16 is fixedly fastened in a circumferential groove 18 around the piston 14. The piston 14 is movable in a reciprocating manner on a connecting rod 19. If the piston 14 is pushed into the cylinder 12, the grooved ring 16 seals a gap 20 between the cylinder 12 and the piston 14, so that air 22 located in the cylinder 12 is compressed to an air pressure p. The compressed air is discharged from the cylinder by a check valve (not depicted), and, during the movement of the piston 14 out of the cylinder 12, air can flow past the grooved ring 16 through the gap 20 in order to be compressed during a subsequent stroke.

The piston 14 is made of plastic by an injection molding process, which has resulted in demolding flash 24, which is depicted schematically by broken lines and extends along a longitudinal axis of the piston 14 and also runs through the groove 18. In order to separate a pressure space 26 from a suction space 28 of the cylinder 12 in an airtight manner, the grooved ring 16 must also bear flush against the piston 14 in the region of the mold parting flash 24. To this end, it has microlips on its static side Sₛₜₐₜ, as shown in detail in FIG. 2. Microlips can also be provided on its dynamic side S_{dyn}, but are not provided in the present case.

FIG. 2 shows the grooved ring 16 in a detailed view. The grooved ring 16 has a sealing lip 30 of substantially constant thickness, said sealing lip 30 lying radially on the outside and having a rounded-off portion at its radially outermost edge 32. At its end remote from the edge 32, the grooved ring 16, which is of substantially V-shaped design, merges into a bearing section 34 in the shape of a cylinder barrel with which it bears against the piston 14 in the groove 18. The bearing section 34 has an axial extent that corresponds substantially to half an axial extent of the grooved ring 16. The inside diameter of the grooved ring 16 in the bearing section 34 is such that it bears without play and with slight force against the piston.

Adjoining the bearing section 34 is a transition section 35 that projects radially inwards and merges into an engagement section 36. At the transition to the engagement section 36, the transition section 35 has a diameter such that it bears with a sufficiently high pressure against the piston 12 (cf. FIG. 1) in order to seal the pressure space 26 with respect to the suction space 28 at the air pressure p, provided the demolding flash 24 is removed. For example, the diameter is 100 μm to 1 mm smaller than the inside diameter of the bearing section 34.

In order to remove the tightness-preventing effect of the demolding flash 24, microlips 38a, 38b, 38c, 38d pointing radially inward are formed in the engagement section 36, the microlips 38a, 38b, 38c, 38d being separated from one another by respective lip roots 40a, 40b, 40c. The microlips 38 project by 0.1 mm to 0.7 mm beyond a base area 42 in the shape of a cylinder barrel and runs through the lip roots 40a, 40b, 40c. The microlips 38 all have substantially the same cross-sectional contour and are arranged concentrically to one another. The microlips have a microlip width b that is less than one tenth of the width B of the grooved ring 16. For example, the microlip width b is less than 1 mm and in particular greater than 0.1 mm. In addition, the microlip width is advantageously less than one fourth of a width N of the engagement section 36 (cf. FIG. 1).

FIG. 3 shows the grooved ring 16 in a three-dimensional view.

To produce the compressor 10, the piston 14 is injection molded and a cylinder casing 44 is produced, which is shown schematically in FIG. 1 and in which cylinders 12 are formed. In addition, the grooved ring 16 is made of rubber and is in particular vulcanized in the process. The grooved ring 16 is then drawn over the piston 14, which is re-worked without chip removal after the injection molding, and is placed in the groove 18. The components are then combined with further construction elements, such as, for example, a belt pulley for driving the connecting rod 19, to build a compressor.

Alternatively, the pneumatic component can also be a pneumatic cylinder. In this case, the connecting rod 19 functions as a push rod. By the admission of compressed air to the pneumatic cylinder, the push rod is pushed out of the cylinder casing 44 and actuates a component to be shifted or moved.

1. A pneumatic component, comprising:
(a) a cylinder (12),
(b) a piston (14) running in the cylinder (12), and
(c) a grooved ring (16) that
(i) seals the piston (14) with respect to the cylinder (12) and has
(ii) a static side (Sₛₜₐₜ) and
(iii) a dynamic side (S_{dyn}), characterized in that the grooved ring (16) has at least two concentric microlips (38) on the static side (Sₛₜₐₜ).

2. The pneumatic component as claimed in claim 1, characterized in that the grooved ring (16) is fastened to the piston (14) such that its static side (Sₛₜₐₜ) faces the piston (14).

3. The pneumatic component as claimed in either of the preceding claims, characterized in that the piston (14) is made of plastic.

4. The pneumatic component as claimed in claim 3, characterized in that the piston (14) is an injection-molded part.

5. The pneumatic component as claimed in claim 4, characterized in that the piston (14) has mold parting flash and the grooved ring (16) is fastened to the piston (14) such that the mold parting flash (24) intersects the microlips (38).

6. The pneumatic component as claimed in one of the preceding claims, characterized in that the microlips (38) project by less than 0.5 mm beyond a base area (42).

7. The pneumatic component as claimed in one of the preceding claims, characterized in that the piston (14) has a diameter of more than 70 mm.

8. The pneumatic component as claimed in one of the preceding claims, characterized in that the grooved ring (16) is made of rubber.

9. The pneumatic component as claimed in one of the preceding claims, characterized in that the grooved ring (16) has a multiplicity of concentric microlips (38).

10. The pneumatic component as claimed in one of the preceding claims, characterized in that it is an air compressor, in particular for a pneumatic system of a utility vehicle.

11. The pneumatic component as claimed in one of claims 1 to 10, characterized in that it is a pneumatic actuator, in particular for a pneumatic gearshift control.

12. A method of producing a pneumatic component as claimed in one of the preceding claims, comprising the steps of:
(a) producing a cylinder casing in which a cylinder is formed;
(b) injection molding a piston having a radially circumferential groove;
(c) producing a grooved ring; and
(d) inserting the grooved ring into the groove,
wherein the grooved ring has a static side and a dynamic side, and characterized in that the grooved ring is produced such that it has at least two concentric microlips on the static side.

13. The method as claimed in claim 12, characterized in that the piston is made of plastic by injection molding.
